(19) United States
(12) Patent Application Publication
(10) Pub. No.: US 2007/0219105 A1
(43) Pub. Date: Sep. 20, 2007

(54) Ionic Additives to Solvent-Based Strippers

(75) Inventors: Galit Levitin, Atlanta, GA (US); Dennis W. Hess, Atlanta, GA (US)

Correspondence Address: BRYAN W. BOCKHOP, ESQ., 2375 MOSSY BRANCH DR., SNELLVILLE, GA, 30078, US

(73) Assignee: GEORGIA TECH RESEARCH CORPORATION, Atlanta, GA (US)

(21) Appl. No.: 11/687,741

(22) Filed: Mar. 19, 2007

Related U.S. Application Data
(60) Provisional application No. 60/783,703, filed on Mar. 17, 2006.

(51) Int. Cl. C11D 7/32

(52) U.S. Cl. 510/175

(57) ABSTRACT

In a removal solution for removing a residue from a substrate, a first interfacial tension exists between the residue and the substrate. The solution includes a polar solvent and an ionic salt. The ionic salt is dissolved into the polar solvent, thereby forming the removal solution. The ionic salt includes at least one ion that, upon dissolution in the solvent, causes the removal solution to have a lower interfacial tension with the residue than the first interfacial tension.

### CROSS-REFERENCE TO RELATED APPLICATION(S)

This application claims the benefit of U.S. Provisional Patent Application Ser. No. 60/783,703, filed Mar. 17, 2006, the entirety of which is hereby incorporated herein by reference.

### BACKGROUND OF THE INVENTION

1. Field of the Invention

The present invention relates to cleaning compositions and processes for stripping photoresist material, such as a fluorinated post-etch crust and underlying unmodified resist, from an electronic circuit and, more specifically, to a method and composition that improves efficiency of a solvent used to strip photoresist material.

2. Description of the Prior Art

Rapidly escalating technological demands have led the semiconductor industry to alter device structures and materials to manufacture higher speed devices. To reduce resistivity and electromigration, aluminum interconnects have been replaced with copper metal. The additional introduction of new low dielectric constant (low-k) materials (such as CORAL™, Black Diamond™, MSQ and parylenes) reduced the resistance-capacitance (RC) delay and thus increased circuit speed. Implementation of these new low-k materials in back-end-of-line processes demands new cleaning techniques with high selectivity that do not degrade the dielectric properties. Standard resist stripping methods that utilize elevated temperatures and oxygen plasmas are not compatible with many of these low-k materials. As a result, liquid cleans are being used alone or in combination with plasma methods to remove resist and etch or implant residue while maintaining the integrity of the copper and low-k materials. Conventional techniques include the use of solvent-based strippers, such as n-methylpyrolidone (NMP) or ethanolamine. When heated, the solvent dissolves the post-etch or post-implant photoresist. Unfortunately, the technique is often not completely effective for resists exposed to high flux/energy plasma etching or ion-implantation processes.

In integrated circuit (IC) manufacture, fluorocarbon-based plasma etching is used to pattern dielectric layers in the fabrication of vias and interconnect structures during back-end-of-line processing sequences. Patterns are defined using standard photolithographic methods with a photosensitive polymer, referred to as a “photoresist.” Fluorocarbon-based plasma etching is then used to transfer the patterns into the dielectric material. To enable anisotropic etching, a thin fluorocarbon layer is deposited on the sidewalls of features, thereby inhibiting lateral etching. In addition, fluorine atoms and fluorocarbon ions bombard the photoresist surface causing the formation of a carbonaceous, fluorinated crust. Prior to subsequent processing steps, this sidewall and photoresist and crust residue must be removed. Incomplete removal of the residue can result in poor adhesion of subsequent film layers, material contamination and inadequate feature size control.

Complete residue removal is frequently hindered by several factors. Crosslinking in the sidewall residue and in the crust often prevents simple dissolution by a solvent. The well-documented low surface energy and inertness of fluorocarbon materials prevent most traditional aqueous chemistries from being completely effective in residue removal. Also, the plasma environment can cause strong adhesion of residues to the underlying substrate and thus change the existing interfacial tension. The chemical structure of the residue is also strongly process- and equipment-dependent, which complicates the development of removal techniques applicable to a broad array of etch chemistries and etch conditions.

Successful residue removal methods typically include a combination of plasma and liquid processing steps. Oxygen-based plasmas and strongly oxidizing liquid chemistries are capable of cleaving carbon-carbon bonds, resulting in successful removal. Other chemistries based on semi-aqueous solutions with fluoride ions are believed to etch the underlying substrate or attack the interface between the substrate and the residue, thus promoting removal by lift-off. Other effective removal methods include solvent-based approaches with selected additives and hydrogen/nitrogen-based non-oxidizing plasmas. However, as the integration of organic-containing low-k materials becomes more prevalent in manufacturing sequences, the use of strongly oxidizing chemistries will be inhibited due to material compatibility concerns.

Solvents play a major role in IC manufacturing since they are used extensively in processing steps such as spin-coating, cleaning, rinsing and drying. A large number of different solvents with wide variation in properties have been employed in the processing steps mentioned above. With regard to solvent properties, there are different approaches to solvent classification. One of the common classifications is based on solvatochromic parameters of the solvent. Solvatochromic parameters describe the hydrogen-acidity, hydrogen-bond activity and polarity-polarizability of the solvent. This approach allows categorization of solvents into five general types: i) slightly basic solvents with low polarity resulting from their aliphatic chains (aliphatic esters and amines); ii) aprotic polar solvents (aliphatic cyclic ethers, esters and ketones, nitriles); iii) strongly basic and strongly polar solvents (pyridines, sulfoxides, ureas, phosphoramides); iv) relatively polar solvents with a low tendency to form hydrogen bonds (aromatic compounds and apolar aliphatic halogenated hydrocarbons); v) amphitropic solvents (alcohols and water) with distinct hydrogen-bonding properties.

During the cleaning process, the residue to be removed should be physically or chemically separated from the underlying substrate or film without altering the unique properties of these materials. This requirement implies that in addition to the interactions between the cleaning chemistry and residue, interactions such as those due to residue-substrate and cleaning chemistry-substrate are involved in the overall process and must be taken into consideration to achieve effective residue removal. Interactions between the solvents and films to be dissolved and removed are in part established by the characteristic parameters of the solvent and the surface. Solvents can alter the interactions between various surfaces by changing the wetting properties of the surface, by promoting separation of surfaces, or by affecting the adhesion between surfaces.

The surface tension of solutions is also an important factor to be considered when designing or selecting cleaning mixtures for microelectronics applications. Decreasing feature size and increasing aspect ratios demand the use of low surface tension fluids or surfactant addition to cleaning solutions to permit effective transport into and out of trenches and other features in device structures. The existence of interactions between the film to be removed and the substrate introduces interfacial tension that is an additional factor to be considered. Interfacial tension describes the inherent incompatibility at an interface between two materials and thus gives an indication of chemical and physical interactions that characterize the stability of the interface.

Development of effective cleaning formulations as well as understanding of the removal mechanisms in IC technology is a complex undertaking because variations in plasma etch chemistry, plasma reactor configuration, photoresist materials, substrate and processing conditions yield diverse residue compositions, bonding structures, chemical properties and physical properties. Similarly, solvent properties vary greatly and must be selected according to the films and residues to be removed. As a result, a specific cleaning chemistry may result in considerable differences in the removal efficiency of apparently identical films and residues.

Two solvents commonly used in residue removal are de-ionized water (“DIW”) and N-Methylpyrrolidone (“NMP”). DIW is water from which (in the ideal case) all impurity ions have been removed. NMP is the lactam of 4-methylaminobutyric acid and a very weak base. NMP is a chemically stable and powerful polar solvent.

Therefore, there is a need for a method and composition for increasing the efficiency of solvents in removing films and residues from integrated circuits while minimizing harm to the underlying materials of the integrated circuits.

### SUMMARY OF THE INVENTION

The disadvantages of the prior art are overcome by the present invention which, in one aspect, is a removal solution for removing a residue from a substrate in which a first interfacial tension exists between the residue and the substrate. The solution includes a polar solvent and an ionic salt. The ionic salt is dissolved into the polar solvent, thereby forming the removal solution. The ionic salt includes at least one ion that, upon dissolution in the solvent, causes the removal solution to have a lower interfacial tension with the residue than the first interfacial tension.

In another aspect, the invention is a method of cleaning a residue from a substrate. A first interfacial tension exists between the residue and the substrate. A polar solvent and an ionic salt are selected so that a solution of the polar solvent and the ionic salt has an interfacial tension with the residue that is lower than the first interfacial tension. The ionic salt is dissolved with the polar solvent, in a predetermined concentration, to form a removal solution. The removal solution is heated to a predetermined temperature. The substrate and the residue are placed into the removal solution while the removal solution is maintained at the predetermined temperature.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

One embodiment of a removal solution for removing a residue (such as a residue from a plasma-etch process that employs a photoresist) from a substrate (such as an integrated circuit), in which a first interfacial tension exists between the residue and the substrate, includes a solution of a polar solvent and an ionic salt. The ionic salt, once dissolved into the polar solvent forms the removal solution. The ionic salt is chosen so that it causes the removal solution to have a lower interfacial tension with the residue than the first interfacial tension.

The polar solvent could include, for example, NMP or de-ionized water. It is understood that other polar solvents (such as other organic polar solvents) could be employed without departing from the scope of the invention. The polar solvent is chosen based on the type of substrate being cleaned and the type of residue being removed.

When the polar solvent is NMP, the ionic salt can be a fluoride salt, such as tetrabutyl fluoride (TBAF) or NH₄F, or an acetate, such as tetramethylammonium acetate (TMAAC). When the polar solvent is de-ionized water, the ionic salt can be a fluoride salt, such as tetrabutyl tetrafluoroborate (TBABF₄), NH₄F and combinations thereof.

In one embodiment, the ionic salt has a concentration of 0.1 M. However, other concentrations may also be employed. Typically, to select the optimal concentration for a given application, one would experimentally try several different concentrations.

The removal solution is heated to a predetermined temperature, which is determined experimentally by heating the solution to several different temperatures and then measuring cleaning efficiency of the solution at each temperature. In one embodiment, the removal solution is heated to a temperature of 70° C. The substrate and residue are placed in the removal solution and the temperature is maintained at the predetermined temperature until the residue is removed from the substrate.

Combining different polar solvents and different ionic salts may improve cleaning efficiency of the removal solution. Also, cleaning efficiency may be improved through agitation (such as ultra-sonic agitation) of the removal solution.

In one experimental embodiment, environmentally benign modifiers were added to conventional organic strippers to enhance their residue removal ability. To find the most efficient additives, various salts at a concentration of 0.1 M were added to NMP (conventionally used as organic stripper in the semiconductor industry) and deionized water (DIW). The cleaning efficiency was tested at 70° C. on fluorocarbon etch residue samples and was compared to the cleaning efficiency of pure solvents. The series of additives included ammonium acetate, ammonium fluoroacetate, tetramethylammonium acetate (TMAAC), sodium acetate, tetrabutyl fluoride (TBAF), ammonium fluoride, tetrabutyl tetrafluoroborate (TBABF₄), ammonium tetrafluoroborate, tetrabutylhexafluorophospahte (TBAPF₆).

The salts were chosen to evaluate the effect of both cation and anion on the removal efficiency of the cleaning formulations. Solvents alter interactions between surfaces by changing the wetting properties of the surface. Pure DI water is incapable of photoresist and etch residue removal due to its low wetting properties. Addition of TBABF₄ and NH₄F to water leads to complete residue removal. These results imply that addition of salt alters the physical properties of the water, changing interfacial tension and allowing better wetting of the surface followed by complete residue removal. Different trends were observed when salts were added to NMP. Addition of TBAF and NH₄F led to complete residue removal.

Fluorocarbon etch residues can be readily removed with the addition of 0.1 M TMAAC to NMP. The salts of carboxylic acids contain atoms bonded to one another by a variety of bond types: nonpolar covalent bonds, polar covalent bonds and ionic bonds. This combination of different bonds in one compound makes these salts very attractive solution modifiers. The positive ion has a significant influence on the cleaning abilities of acetate salts. Among all the acetate salts tested, TMAAC in NMP was effective in residue removal. The addition of ammonium acetate or sodium acetate improves the residue removal in water. These results may be due to the alteration of specific solution properties: pH change, electrical conductance change, as well as changes in interfacial properties of the formulation vs. pure solvents.

To optimize cleaning solution formulation, both the effect of the solvent and the addition of ionic solvent modifiers should be evaluated. A broad variety of solutions are used for cleaning and surface preparation in the IC industry including low-molecular weight alcohols, aqueous-organic solutions, and conventional organic solvents with additives. Selection of the appropriate solvent can dramatically improve the overall effectiveness of the final cleaning solution formulation. In addition, specific additives can also enhance wetting and transport of active components, modify solubility and improve overall cleaning effectiveness. Addition of salts to photoresist developer solutions strongly affect the photoresist dissolution process.

The following reports one experimental embodiment of the invention. In the experimental embodiment, model fluorocarbon residues have been generated by plasma-assisted deposition. These planar etch residue samples were formed by exposing silicon wafers in parallel plate reactors to C₄F₈-based fluorocarbon plasma processes for various times. Typical deposition conditions were: C₄F₈-30 sccm, O₂-6 sccm, Ar-120 sccm, substrate temperature-120° C., power-300 W, pressure-0.79 Torr. Under these conditions, the deposition rate of the fluorocarbon film was 2.1±0.5 nm/s.

The deposited residue samples were similar to the fluorocarbon crust observed on top of the photoresist generated during plasma etching of patterned samples with respect to film composition and bonding structures as indicated by X-Ray Photoelectron Spectroscopy (XPS) analysis. Model residue samples gave comparable bonding structures to those of residues at the via bottom; sidewall residue compositions were not measured in this study. These model residue films ranged in thickness between 100 nm and 200 nm. XPS measurements yielded a composition of 45% carbon, 50% fluorine and 5% oxygen for a first set if samples and 48% carbon, 46% fluorine, 1% nitrogen and 5% oxygen for a second set of samples. Samples were cleaved into 1 cm² samples and treated with various chemical solutions.

Patterned fluorocarbon residues: Patterned etch residue samples were generated by etching a low-k SiO₂-based film stack in a C₄F₆-based plasma. The patterns consisted of arrays of vias ranging in size between 130 and 1000 nm. The dual-damascene low-k etch stack consisted of 625 nm of photoresist (such as the family of the PHOST/TBOC based photoresists, e.g., TBOC protected poly-hydroxystyrene), 60 nm BARC (bottom anti reflecting coating), 50 nm SiO₂, 1000 nm Coral™, 70 nm SiC, and 500 nm SiO₂. After the etch process, approximately 400 nm of fluorocarbon residue and photoresist remained on the silicon dioxide hard mask. The thickness of the fluorocarbon residue on the patterned samples has been estimated to be 7.8 nm.

Contact angle measurements were performed using an AST Products Model VCA 2500XE video contact angle system. To measure the contact angle, a 1 to 5 microliter drop of a liquid was placed on the sample using a computer controlled micro-syringe. A video capture device recorded the picture of the drop on the surface. Using the outline of the drop, the contact angle was calculated based on the captured image. The average of at least three measurements is reported with measurement variability typically +/−30 or less.

The surface tensions of various solutions and pure solvents were measured using the pendant drop method with First Ten Angstroms, Inc (FTA) 200 contact angle goniometer. The surface tension was determined by fitting the shape of the drop (in a captured video image) to the Young-Laplace equation, which relates interfacial tension to drop shape. Each solvent was measured at least 5 times and the average value was used for subsequent calculations.

AFM measurements were performed using a Pico Plus instrument by Molecular Imaging in tapping mode using an Acoustic Ac Sample cantilever at the resonant frequency of 160 kHz. Initial measurements were performed on the etch residues before cleaning. Subsequently, the residue sample was exposed to the cleaning solution at 70° C. for 10 min. The sample was dried in nitrogen gas and the AFM image monitored. The cleaned sample was then rinsed with methanol, dried in nitrogen gas, and additional AFM images obtained. The AFM measurements allowed changes in surface morphology as a result of cleaning and rinsing of samples to be assessed.

All chemicals were reagent grade or better. Deionized (DI) water had a resistivity of 18 MΩ-cm. Chemicals were used without further purification. Sample treatments in the various solutions were performed by immersion.

The dissolution/lift off of a solid material in a liquid can be described by a multi-step process: (1) wetting of the thin films and/or interface between the film and the substrate, displacing entrapped air, (2) deaggregation and/or fragmentation of the film or residue, thereby creating particle clusters, (3) prevention of reaggregation of the dispersed particles. Wetting of the solid surface must occur in order for the solid to become partially dispersed in the liquid or for chemical reaction to take place. Thus for residue cleaning or removal, wetting of the solid by the liquid must be thermodynamically favorable. In addition, for the situation where residue removal is not dissolution-based but is controlled by lift-off, the interfacial tension between the residue and the substrate and its change as a function of solution chemistry becomes an important factor in the removal process.

Young's equation describes the relationship between the solid surface energy, γₛ, the solid/liquid interfacial surface energy of a liquid, γₛₗ, the air/liquid surface energy or surface tension, γₗ, and the contact angle of a liquid drop on a surface, 0, as indicated in Equation (1). Either the surface energy or the interfacial surface energy must be known for this equation to be applied to specific systems.

γₛ=γₛₗ+γₗ cos θ (1)

Owens and Wendt postulated that the Gibbs free energy associated with the interaction of a drop of liquid on a surface is equal to the interfacial surface energy, γₛₗ, minus the surface tension, γₗ, and the surface energy, γₛ. Based on empirical observations, Owens and Wendt formulated an expression for the Gibbs free energy of interaction that depended on the geometric mean of the dispersive and polar contributions to the surface tension and surface energy as shown in Equation (2). Their data clearly indicated that the polar and dispersive contributions for both surface tension and surface energy are additive.

ΔGₛₗ=γₛₗ−γₛ−γₗ=−2[(γₗ^{d}γₛ^{d})^{1/2}+(γₗ^{p}γₛ^{p})^{1/2}] (2)

It can be shown mathematically that the free energy is minimized (maximum interaction) when the percentages of polar and dispersive contributions of the solvent and surface are equal. This result yields the smaller contact angle and agrees with physical intuition. By combining Equations (1) and (2), Owens and Wendt obtained Equation (3) where the contact angle is related to the dispersive and polar contributions.

(γₗ^{d}γₛ^{d})^{1/2}+(γₗ^{p}γₛ^{p})^{1/2}=γₗ(cos θ+1)/2 (3)

If the liquid surface tension is known, the dispersive and polar contributions to the surface tension can be determined by measurement of the contact angle of the liquid on polytetrafluoroethylene (PTFE). Since PTFE participates only in dispersive interactions (γₛ^{p}=0) and the surface energy has been previously characterized (γₛ=18 mJ/m²), Equation (3) simplifies to Equation (4). However, if the surface tensions of the liquid cleaning solutions are unknown; these values may be determined experimentally by the pendant drop technique.

γₗ^{d}=[γₗ(cos θ_{ptfe}+1)]²/72 (4)

To determine the overall surface energy and the polar/dispersive contributions of an unknown surface, the contact angle of two previously characterized probe liquids are measured on the unknown surface. Substitution of the resulting values into Equation 3 results in a system of two equations and two unknowns.

For cleaning applications, it is desirable that the residue or surface film be removed either by dissolution or by interfacial wetting which results in lift-off. One approach to the development of cleaning solution formulations, is to select chemistries that minimize the free energy in Equation (2). When the surface tension of the solvents is approximately equal to the surface free energy, minimization of the free energy is equivalent to matching the dispersive and polar contributions of the surface tension to that of the surface energy. When the surface tension values vary significantly, the magnitude of the free energy can be skewed by the solution with the largest surface tension. For example, the free energy associated with a fluorocarbon surface and water, with a surface tension of 72 mN/cm, is much larger than that of a fluorocarbon surface with dimethylformamide (37.1 mN/cm). An alternate approach is based on the selection of chemistries that have lower interfacial tension with the residue than that between the residue and substrate. As mentioned above, despite the fact that interfacial tension is influenced by the original surface energies of the residue and substrate as well as by the compatibility of the two materials in terms of surface polarity, interfacial tension is a fundamental property of the interactions at the interface between the residue and the substrate.

The change in interfacial tension can be also estimated by use of the Owens-Wendt model. That is, the interfacial tension of the residue and film (γₛ₁₂) is calculated from Equation (2), where instead of γₛ and γₗ, values of γₛ₁ and γₛ₂ are used. The change in “separation” energy (energy required to separate a film from a surface of a substrate) is then calculated from:

ΔG=γₛ₁₁+γₛ₂₁−γₛ₁₂ (5)

A smaller value of ΔG indicates a higher probability that the film will lift-off from the surface of the substrate. The combination of matching the percentage contributions for dispersive and polar segments of surface energies and selecting liquids with appropriate differences in interfacial tension relative to the surfaces will be shown below to be useful in evaluation of the cleaning solutions.

Characterization of surfaces: Unknown surfaces are characterized by measurement of the contact angle of two different probe liquids such as diiodomethane (which participates only in dispersive interactions) and water (which participates in both dispersive and polar interactions) on the surface. Results for the various surfaces investigated are shown in Table I, as follows:

TABLE I
Surface energy component results of selected surfaces.

| | | | | | Total | | |
|---|---|---|---|---|---|---|---|
| | Diiodomethane | Water | | | surface | | |
| | contact | contact | γₛ^{d} | γₛ^{p} | energy, γₛ | γₛ^{d} | γₛ^{p} |
| Surface | angle | angle | (mJ/m²) | (mJ/m²) | (mJ/m²) | (%) | (%²) |
| model residue | 77.0° | 92.0° | 19.1 | 3.5 | 22.6 | 85 | 15 |
| Patterned residue | 61.0° | 25.0° | 27.9 | 38.5 | 66.4 | 42 | 58 |
| PTFE | 78.7° | 114.4° | 18.1 | 0.01 | 18.1 | 100 | 0 |
| PHOST | 61.0° | 46.0° | 36.7 | 11.2 | 48.0 | 77 | 23 |
| FC deposited on Si | 82.9° | 102.4° | 16.0 | 1.4 | 17.4 | 92.2 | 7.8 |
| HSQ | 77.8° | 103.9° | 18.7 | 0.6 | 19.3 | 96.7 | 3.3 |
| Coral ™ | 64.1° | 98.5° | 26.2 | 0.5 | 26.7 | 98.3 | 1.7 |
| Silicon wafer | 47.7° | 17.3° | 35.6 | 35.4 | 70.9 | 50.1 | 49.9 |
| SiO₂ | 48.3° | 31.8° | 35.2 | 29.2 | 64.5 | 54.6 | 45.4 |

The model residues were generated by exposure of a silicon substrate to the fluorocarbon plasma environments described previously. The surface energy of the first film discussed above was calculated according to the Owens/Wendt model to be 22.6 mJ/m2 with a dispersive contribution of 85%. The surface energy of the second film was 17.4 mJ/m2 with a dispersive contribution of 92.2%. As noted in the above, the film composition and bonding structures are quite similar; both films have surfaces that are highly fluorinated. Nevertheless, slight differences in surface properties and solution interactions result, no doubt because of subtle differences in bonding structures and composition.

Contact angle measurements were also performed on patterned (etch) residue samples. The contact angle was measured primarily in open areas where no vias were present. The exact area of open space varied from sample to sample but ranged between 30 and 70%. Contact angles did not depend significantly on the presence or absence of vias; good repeatability with variations of +/−3 degrees were observed. The photoresist/residue surface can be described as a polyhydroxystyrene-based (PHOST) photoresist bombarded by fluorocarbon ions and atoms during the etching process. The surface composition after etch was 71% carbon, 10% fluorine, 15% oxygen and 4% nitrogen.

Despite the lower fluorination of the residue relative to the planar model residue, the composition and bonding structure of the model film are similar to those of the etch residue samples. The surface energy was calculated to be 66.4 mJ/m2 with a dispersive contribution of 42%. Although the model residues and patterned etch residues have similar chemical compositions, the latter have much higher surface energy (˜3 times). Such differences may be partly explained by the fact that the patterned etch residues include a stack of materials, mainly a photoresist layer (however underlying layers can also contribute to the residue formation) which was exposed to a fluorocarbon-based etch process that resulted in the formation of 7-8 nm of a fluorocarbon crust; however, the model residues were formed by plasma deposition of a fluorocarbon film on the silicon substrate that was initially covered with a native silicon dioxide layer. The difference in surface energy may result from differences in processing, film thickness, roughness and uniformity, as well as introduced spatial geometry (in the case of patterned residues). Such differences highlight the difficulties involved in formulating cleaning solutions that are effective for a variety of plasma etch processes.

Comparison of the surface energy of patterned etch residues with that of virgin PHOST (polyhydroxystyrene photoresist) films also demonstrates significant differences in surface energy values for PHOST films which have a surface energy of 48.0 mJ/m2 with a 77% dispersive contribution. The reduction in dispersive character of the patterned residue film is significantly lower than that of the virgin film which may be due to the formation of a cross-linked network under plasma exposure and the incorporation of polar C-F bonds into the residue during the plasma etch process. Such results imply that a fluorocarbon film is not simply deposited on the surface of the photoresist, but has bonded into the polymer surface.

In order to better understand the effect of interfacial tension between the residue and substrate in cleaning or residue removal, the underlying material for these residues was also characterized. For model residues, the underlying material is a silicon substrate with a native silicon dioxide layer. The surface energy of this material is 64.5 mJ/m² with a dispersive contribution of 54.6%. For the patterned photoresist residue samples, characterization of the underlying material is more complicated since it includes BARC, silicon dioxide and Coral™. At the top of the features, a silicon dioxide capping layer separates the photoresist residue from the low-k dielectric; however, sidewall fluorocarbon residue is deposited directly on the Coral™ material. For this reason, both a silicon dioxide film and a Coral™ film were analyzed. The surface energy of a blanket Coral™ film was 26.7 mJ/m2 with a dispersive contribution of 98.29%. A 500 nm thermally grown silicon dioxide surface resulted in similar surface energy values to those of the silicon wafer.

A variety of solvents were characterized using the Owens-Wendt analysis technique. To determine the dispersive contribution to the surface energy, the contact angle of a specific solution was measured on a polytetrafluoroethylene surface (PTFE), which participates in only dispersive interactions. The polar contribution of the surface tension is calculated by subtracting the dispersive contribution from the total surface tension of the liquid.

The specific solvents selected for study were dimethylformamide (DMF), n-methylpyrrolidone (NMP), dimethylsulfoxide (DMSO), tetrahydrofuran (THF) and acetonitrile. Water and diiodomethane were included because of their utility as probe liquids. The surface tension and polar/dispersive contributions are listed in Table II.

TABLE II
Surface tension component results of selected solvents.

| | | Contact | | | | |
|---|---|---|---|---|---|---|
| | | angle | | | | |
| | Surface | measured | | | | |
| | tension | on | γₗ^{d} | γₗ^{p} | | γₗ^{p} |
| Solvent | (mJ/m²) | PTFE | (mJ/m²) | (mJ/m²) | γₗ^{d} (%) | (%) |
| NMP | 40.3 | 74.3° | 36.4 | 3.9 | 90 | 10 |
| DMSO | 43.0 | 84.9° | 30.5 | 12.5 | 71 | 29 |
| DMF | 37.1 | 74.1° | 31.0 | 6.1 | 84 | 16 |
| Acetonitrile | 19.1 | 63.4° | 10.6 | 8.5 | 56 | 44 |
| THF | 26.4 | 42.0° | 29.4 | −1.3 | 100 | 0 |
| Diiodomethane | 50.8 | 78.7° | 52.8 | −1.8 | 100 | 0 |
| Water | 72.8 | 113.3 | 26.8 | 46.0 | 37 | 63 |

Dispersive contribution percentages ranged from 56% to 100%. Calculations of the dispersive contribution to surface tension resulted in values slightly larger than the total surface tension and gave unrealistic negative values of polar contribution (Table II for THF and Diiodomethane) Such results are caused by errors related to measurement of the surface tension and contact angle. For example, by assuming that diiodomethane is 100% dispersive, the expected contact angle on PTFE is 79.0° whereas the value measured was 78.8°, within experimental error. The percentage values for the dispersive contribution of diiodomethane and THF are therefore approximated to 100%.

Results from this analysis can be compared to the Hansen Solubility Parameter for each solvent, which represents a similar solvatochromatic scale for solvents and polymers. The Hansen solubility parameter separates molecular interactions into dispersive, polar and hydrogen bonding values; the square root of the sum of squares of these three values is set equal to the Hildebrand solubility parameter. The matching of percentage contributions for dispersive and polar segments of surface energies and solvent parameters is an important consideration in effective residue removal. Since the surface energy of both model and patterned etch residue exhibits a high dispersive component contribution, we also examined the dispersive component of the solvent parameters. Each data point is normalized by its total value (Hansen parameter is normalized by Hildebrand solubility parameter, while Owens-Wendt dispersive value is normalized by the total surface tension).

The advantage of the Owens-Wendt analysis is that solvent characterization can be performed simply by measurement of a single contact angle, assuming that the liquid surface tension is known. The Hildebrand parameter is related to the square root of cohesive energy density of the solvent which can be determined from the heat of vaporization. However, determination of Hansen or Hildebrand parameters for solids or surfaces is more complex for several reasons. For instance, it is generally difficult to measure the heat of vaporization of films, and measurements performed are based on an estimation of the film swelling or on cloud-point determination in situations when the films are soluble in true solvents. These measurements are complicated and time consuming.

The Owens-Wendt analysis predicts that the interaction energy will be maximized when the polar and dispersive contributions of the surface match those of the liquid. Swelling, dissolution or interfacial wetting of the residue by a specific solvent becomes more likely as the interaction energy is maximized.

Both model and patterned residue samples were exposed to the solvents previously characterized. When the model residues were immersed in solutions of DMF, NMP and DMSO, the film delaminated from the silicon substrate. Exposure to DMF caused the most rapid delamination, which occurred within 15 seconds of immersion. The two other solvents caused film delamination after two minutes; however, the films did not dissolve in these solvents due to the heavy crosslinking present. Exposure to the other solvents did not cause delamination. Twenty minute immersion of the samples in THF and acetonitrile resulted in minor surface roughening. Water exposure did not visibly affect the model fluorocarbon film; XPS surface analysis confirmed that chemical exposure did not alter the surface chemistry of the films.

The wetting, solvent absorption and subsequent delamination of the model films are believed to be a result of the chemical similarity to the solvents as measured by the Owens-Wendt analysis. The percentage of dispersive and polar contributions between the film and DMF are nearly identical (Tables I and II). Chemical similarity between DMSO and NMP and the fluorocarbon residue was also high. The percentage difference between THF and DMSO dispersive contributions and the residue dispersive contribution was 14-15%. This observation is consistent with the absence of moderately polar chemical moieties in THF. It is interesting to note that the change in “separation” energy is also consistent with the experimental data. The interfacial tension between SiO₂ and the fluorocarbon residue was calculated based on the Owens-Wendt model; the interfacial tension between the solvent and each surface was then calculated, and finally “separation energy” was determined from Equation 5. Smaller “separation energy” values are obtained for solvents that cause faster delamination of the film (Table III). These results clearly demonstrate the complex mechanism of residue removal, especially when surface energies and interfacial tensions both play essential roles in the removal process.

Solvent immersion of patterned residue samples yielded similar results. The virgin photoresist, PHOST, is soluble in all of the characterized solvents except water. Removal of the residue requires penetration of the solvent through the fluorinated crust, and either dissolution of the photoresist or interfacial wetting at the photoresist/substrate to promote delamination. Visual observation of the residue removal indicated that removal occurred by delamination of the entire photoresist/crust layer suggesting that the photoresist is significantly crosslinked. Indeed, crosslinking occurred either as a result of a hardening process prior to the plasma etch process to increase etch resistance, or during the plasma etch sequence due to radiation exposure.

The patterned etch residue consisted of open areas spaced between via regions. Removal was assessed qualitatively by optical micrograph images. Solvent exposure was ineffective in residue removal in near proximity to vias; however, residue removal was observed in the open areas between vias. Specifically, immersion in DMF and DMSO caused effective removal of the residue within two minutes. Exposure to NMP and acetonitrile was moderately effective, although residue removal was typically incomplete after twenty minutes. Sample immersion in THF caused wrinkles in the residue with little removal. Water exposure caused no visible changes to the residue surface.

The percent dispersive character (44%) of the patterned residue suggests that acetonitrile (56% dispersive) or even water (34% dispersive) should be more effective than DMF (84%), DMSO (71%) or NMP (91%) exposure in residue removal. However, the results were opposite to this expectation. When “separation energy” was calculated at the interface of SiO₂ and the patterned residue, results more consistent with the experimental observations were obtained (Table III).

TABLE III
The change in separation energy at interface of SiO₂/AP model residue
(with interfacial tension of 15.2 mJ/m²), at interface SiO₂/
Patterned etch residue (with interfacial tension of 1.1 mJ/m²) and
at interface Coral ™/Patterned etch residue (with interfacial
tension of 30.4 mJ/m²).

| | Separation | | |
|---|---|---|---|
| | energy at | Separation energy | Separation energy |
| | the interface | at the interface | at the interface |
| | SiO₂/AP | SiO₂/Patterned | Coral ™/Patterned |
| Solvent | model residue | Etch Residue | Etch Residue |
| NMP | 0.1 | 30.3 | −9.0 |
| DMSO | −7.3 | 10.0 | −15.0 |
| DMF | −4.5 | 22.0 | −13.0 |
| Acetonitrile | 0.7 | 27.5 | −7.1 |
| THF | 19.1 | 67.8 | 8.6 |
| Diiodomethane | 26.9 | 71.9 | 16.0 |
| Water | 12.3 | 1.9 | 7.4 |

An exception was found for the case of water. The separation energy of surfaces is lowest when in contact with water. However, no cleaning is observed when patterned etch residues are exposed to pure DI water. Such discrepancies may arise from the fact that post-plasma etch residues are a complex mixture of materials whose exact composition and bonding structure depend on the etch gas and plasma conditions, but the resulting film stress and adhesion can also depend on the geometry and composition of the features. For instance, on via sidewalls, fluorocarbon films are deposited directly on the low-k material. To examine how this change can affect the results, the “separation” energy was also calculated for the interface of Coral™/Patterned Etch Residue (Table III). The results clearly support the experimental observation. Immersion in THF, water or diiodomethane results in high “separation” energy indicating that the film lift off is not thermodynamically favorable. Although the value of “separation” energy provides a possible parameter to evaluate the cleaning efficiency of different solvents, several additional important issues must be considered when applying this analysis to patterned etch residues.

The photoresist residue ‘crust’ layer is comprised of a tough carbonaceous region located at the photoresist surface with essentially virgin photoresist beneath. A dispersive character of 44% was measured for the top portion of this layer, while the underlying photoresist layer should be chemically similar to pure PHOST, which displayed 77% dispersive character. Furthermore, the existence of the BARC layer can also affect the “separation” energy. Additional errors can result from experimental measurements of contact angle on patterned etch residues.

The presence of vias makes accurate measurements difficult, thereby yielding inconsistent results. Thus, this experiment relating to model films can offer insight into the mechanisms controlling residue removal, but such approaches should only be used as a general guide to assist the formulation of solvents for removal of post-etch residues.

The virgin residue (not exposed to any solvent) was relatively thick and covered much of the via opening, thereby forming an embedded crater. Exposure to NMP lead to significant swelling in the via regions including the area near the via entrance. The via structures may inhibit lift-off, probably because the residue is chemically attached to the sidewall. Extensive cracking of the residue was observed in open areas between the patterns.

Chemically, the sidewall residue was most similar to the model residue films; however, comparable dissolution behavior was not observed upon solvent exposure. These differences are likely caused by the fact that the underlying materials are not the same (Coral™ versus silicon dioxide) or because plasma/radical fluxes were different in the different reactors used to generate the samples. Furthermore, the organic nature of the underlying low-k material may result in enhanced residue adhesion, which is consistent the observed results. An MeOH rinse after NMP exposure eliminates polymer swelling between the vias. However, comparison to the initial morphology indicates that etch residues attached to side walls are still swollen, thereby creating a protruding crater. Exposure of the residues to water did not cause observable morphological changes of the residue surface.

Salt addition to a photoresist developer solution had a significant effect on photoresist dissolution. The addition of various salts may have analogous effects on the removal efficiency of fluorocarbon-based residues in DIW and NMP solutions. Therefore, the properties of a number of 0.1 M salt solutions and the fluorocarbon and residue surfaces described above were evaluated using the Owens-Wendt analysis technique. Surface tensions of the salt solutions were measured using the pendant drop method; the salts investigated include lithium tetrafluoroborate (LiBF₄), ammonium tetrafluoroborate (NH₄BF₄), tetrabutylammonium tetrafluoroborate (TBABF₄), ammonium fluoride (NH₄F), tetrabutylammonium fluoride (TBAF) and tetramethylammonium acetate (TMAAC). This series of salts was selected to investigate the effects of anion/cation size and chemical functionality as well as to allow a comparison to the Hofmeister series.

The contribution of polar and dispersive components was calculated in the manner previously described for solvent analysis. The results summarized in Table IV, below, indicate that addition of organic salts with relatively large anions and cations such as TMAAC, TBAF, and TBABF₄ significantly reduces the surface tension of water. Analogous additions to NMP show little effect on the total surface tension. Also, addition of any of the salts to DIW causes a reduction in the polar component of the surface tension compared to pure DIW. In NMP, only lithium acetate (LiAc), LiBF₄ and NH₄F additions yield a reduction in the polar component of the surface tension; all other additives cause an increase in the polar component of surface tension relative to pure NMP.

TABLE IV
Surface tension component results of salt solutions at 0.1 M concentration.

| | | | Contact angle | | | | |
|---|---|---|---|---|---|---|---|
| | | Surface tension | measured on | γₗ^{d} | γₗ^{p} | γₗ^{d} | |
| Solvent | Salt | (mJ/m²) | PTFE | (mJ/m²) | (mJ/m²) | (%) | γₗ^{p} (%) |
| DIW | Pure | 72.80 | 113.34 | 26.83 | 45.97 | 36.86 | 63.14 |
| DIW | LiBF₄ | 71.46 | 103.32 | 42.02 | 29.44 | 42.34 | 57.66 |
| DIW | NH₄BF₄ | 71.23 | 106.25 | 36.55 | 34.68 | 51.31 | 48.69 |
| DIW | TBABF₄ | 51.21 | 99.87 | 25.01 | 26.20 | 48.84 | 51.16 |
| DIW | NH₄F | 71.98 | 110.44 | 30.48 | 41.50 | 42.34 | 57.66 |
| DIW | TBAF | 59.03 | 105.24 | 26.30 | 32.73 | 44.55 | 55.45 |
| DIW | LiAc | 71.99 | 110.55 | 30.31 | 41.67 | 42.11 | 57.89 |
| DIW | NH₄Ac | 72.12 | 114.68 | 24.50 | 47.62 | 33.97 | 66.03 |
| DIW | TMAAC | 69.45 | 116.63 | 20.39 | 49.06 | 29.36 | 70.64 |
| NMP | Pure | 40.31 | 74.32 | 36.42 | 3.89 | 90.34 | 9.66 |
| NMP | LiBF₄ | 39.74 | 70.87 | 38.66 | 1.08 | 97.29 | 2.71 |
| NMP | NH₄BF₄ | 36.15 | 77.06 | 27.18 | 8.96 | 75.20 | 24.80 |
| NMP | TBABF₄ | 40.17 | 76.37 | 34.22 | 5.95 | 85.19 | 14.81 |
| NMP | NH₄F | 39.67 | 73.58 | 35.95 | 3.72 | 90.63 | 9.37 |
| NMP | TBAF | 40.40 | 77.71 | 33.33 | 7.06 | 82.52 | 17.48 |
| NMP | LiAc | 40.41 | 74.23 | 36.68 | 3.73 | 90.77 | 9.23 |
| NMP | NH₄Ac | 40.24 | 75.06 | 35.58 | 4.66 | 88.42 | 11.58 |
| NMP | TMAAC | 40.25 | 79.83 | 31.15 | 9.10 | 77.40 | 22.60 |

TBA⁺ = Tetrabutylammonium cation

After characterization of salt solutions by Owens-Wendt analysis, a contact angle between salt solutions and the various surfaces can be predicted. Differences between the predicted and measured contact angles can be used to evaluate consistency with the model. TMAAC, TBABF4 and TBAF in water and NMP have been chosen for this purpose due to their ability to clean patterned etch residues. The surfaces tested included hydrophobic surfaces such as PTFE, Coral™, HSQ, model residue films, a moderately hydrophobic surface (e.g., native-oxide-covered Si) and a hydrophilic surface, e.g., SiO₂. Interactions between patterned layers with etch residues and different solution additives were also investigated.

Predicted contact angles agreed more closely with measured values on the more hydrophobic surfaces. Larger discrepancies between the predicted and measured contact angles were observed on the Si, SiO₂, and patterned etch residue surfaces. The discrepancies observed for NMP-based salt solutions were larger than those for water. In nearly all cases (especially in NMP based solutions), the measured contact angle was less than the predicted value. The discrepancy between measured and calculated contact angles may indicate that chemical and physical interactions occur between the solvents and surfaces which alter the surface properties. Si and SiO₂ surfaces are extremely sensitive to the chemical environment which can explain the higher contact angles measured on Si and SiO₂ surfaces relative to calculated contact angles. Indeed, it has been reported previously that the variability of the contact angle on Si and SiO₂ surfaces depends upon the thermal and chemical history of those surfaces. These results indicate that the model is more suitable to low energy surfaces, and additional interactions (e.g., coulombic, chemical interaction), geometry and processing history should be taken into consideration when considering high energy, reactive surfaces.

Table V, below, summarizes the cleaning results for various salt additives to DIW and NMP. Clearly, a simple matching of dispersive and polar components of the modified solvents with those of the tested surfaces does not explain the cleaning results (Table II, IV and V). In essentially all cases, the dispersive contribution of DI water solutions after addition of the salts matches the dispersive component of patterned etch residues, but not that of the model etch residue. However, not all added salts result in efficient cleaning. This conclusion is also consistent with the tests performed on the NMP modified solutions.

TABLE V
Evaluation of residue removal using salt modified solutions.

| | | Water-based | | NMP-Based | |
|---|---|---|---|---|---|
| | | solution | | solutions | |
| Salt added | | Interfacial | Removes | Interfacial | Removes |
| Cation | Anion | tension, γₛₗ | residue? | tension, γₛₗ | residue? |
| no | no | 33.1 | No | 4.8 | No |
| Li⁺ | BF₄⁻ | 24.3 | Yes | 4.9 | No |
| NH₄⁺ | BF₄⁻ | 26.5 | Yes | 4.8 | No |
| TBA⁺ | BF₄⁻ | 16.6 | Yes | 5.0 | No |
| NH₄⁺ | F⁻ | 30.1 | Yes | 4.5 | Yes |
| TBA⁺ | F⁻ | 22.0 | No | 5.3 | Yes |
| Li⁺ | Ac⁻ | 30.2 | No | 4.8 | No |
| NH₄⁺ | Ac⁻ | 33.8 | No | 4.8 | No |
| TMA⁺ | Ac⁻ | 34.3 | No | 5.8 | Yes |

These results demonstrate that a mere match of the surface energies does not necessarily serve as good predictor of cleaning efficiency when ionic salts are used as solution modifiers.

Another possible correlation to allow prediction of cleaning with salt modifiers involves the effects of cations and anions. One of the conventional approaches to photoresist and post etch residue cleaning is utilization of so-called semi-aqueous chemistries (SACs). SACs (pH between 8 and 10) consist of water, an organic solvent and a small amount of buffered fluoride salt which is the chemically active species. In many cases, their use in residue removers has resulted in unacceptable levels of critical dimension (CD) loss in vias etched in SiO₂ or organic low-k material (SiLK™) even if used at very low concentrations. Thus, the effect of fluoride-containing salts on the cleaning efficiency was also studied; the salt concentration remained constant, and comparisons were made based on the nature of the cation and anion. Results in Table V demonstrate that the effect of these additives on cleaning and residue removal in water and NMP solutions are quite different. When the patterned residues were cleaned in a water solution with additives containing the BF₄ anion at T=70° C., the residue film delaminated from the substrate within 5 minutes. Exposure to the TBAF/DI water solution (at 70° C.) did not cause delamination even after 1 hour of immersion. Furthermore, exposure to pure water did not alter the postetch residues.

XPS analyses confirmed that solution exposure did not alter the surface chemistry of the films. These results are interesting in that both TBAF and TBABF₄ are expected to form HF and consequently HF₂ via salt hydrolysis. HF₂ can etch the underlying layer of SiO₂ and remove photoresist and plasma etch residues through a lift off mechanism. However, a significant difference in the cleaning behavior of BF₄ and F anions was demonstrated.

To further investigate this observation, AFM analysis of the surface morphology after exposure of etch residues to the different additives in DIW and NMP has been performed Exposure to TBAF/DIW did not change the surface morphology of the residue; that is, no swelling or cracking was observed. However, exposure to the TBAF/NMP solution did affect the surface in that the residues are cracked and swollen, with residues lifting off even on the sidewalls of the vias. A subsequent rinse in MeOH yielded complete residue removal, although the areas around the vias appear to have been etched slightly. However, the MeOH rinse after TBAF/DIW exposure did not result in residue delamination. Different results were obtained when the patterned etch residues were exposed to TBABF₄/DIW or TBABF₄/NMP. In particular, TBABF₄ was deposited on the residue surface after exposure to TBABF₄/DIW. This deposition interferes with tapping mode AFM scans due to the presence of crystals on the surface. After an MeOH rinse, a clean surface was obtained, at least to the detectability limit of XPS measurements. Although the residues, including sidewall residues, were removed, the surface was roughened. Exposure of samples to TBABF4/NMP solutions caused cracking and swelling of the residues in the via area, with only partial removal of the residues in open areas. A rinse in MeOH did not cause further residue delamination. Thus, the cleaning efficiency depends not only on the specific chemistry of the added salt, but also on the solvent used. This implies that etching of the underlying SiO₂ layer is not the only removal mechanism but additional factors such as salt salvation, surface-surface, and surface-solvent interactions are playing significant roles.

The effect of a change in interfacial tension between the residue/substrate subsequent to immersion in the ionic modified solvents was also estimated. “Separation” energies for the interface model films/SiO₂, patterned etch residues/SiO₂ and patterned etch residues/Coral™ were calculated (see, Table VI, below). The specific chemistries were chosen on the basis of their cleaning efficiency and specific cleaning behavior (as mentioned above, TBAF vs TBABF₄). These results demonstrate that for different cleaning chemistries, changes in “separation” energy due to changes in interfacial tension between the residue and substrate, can provide qualitative guidelines to estimate the efficiency of those chemistries. However, other factors such as residue/substrate processing history, plasma etch tool, specific film stacks on the substrate, must also be considered for final solution formulation. In addition, use of patterned etch residues offers little insight into the controlling factors in residue removal due to their complex geometrical and chemical structures. Model residues are more amenable to the investigation of more fundamental interactions of solvent/residue, residue/substrate, and solvent/substrate interactions.

TABLE VI
The change in separation energy at interface of SiO₂ plasma deposited
model residue (with interfacial tension of 21.7 mJ/m²), at interface
SiO₂/Patterned etch residue (with interfacial tension of 1.1 mJ/m²)
and at interface Coral ™/Patterned etch residue (with interfacial
tension of 30.4 mJ/m²).

| | | | Separation energy at |
|---|---|---|---|
| | Separation | Separation energy | the interface |
| | energy at the | at the interface | Coral ™/ |
| | interface SiO₂/ | SiO₂/Patterned | Patterned Etch |
| Salt/Solvent | model residue | Etch Residue | Residue |
| no/water | 14.0 | 1.9 | 7.4 |
| TBABF₄/water | −4.1 | 1.1 | −9.6 |
| TBAF/water | 1.0 | −0.1 | −4.9 |
| TMAAC/water | 17.2 | 4.7 | 11.1 |
| No/NMP | −5.0 | 29.2 | −9.6 |
| TBABF₄/NMP | −7.8 | 22.2 | −12.4 |
| TBAF/NMP | −8.7 | 19.3 | −13.4 |
| TMAAC/NMP | −9.9 | 15.0 | −14.6 |

Preliminary studies of surface chemical and physical properties have demonstrated that chemical similarity between solvent and surface through the matching of polar and dispersive components allow initial evaluation of cleaning mixtures for post-plasma etch residue removal. Addition of ionic salts to DI water or NMP, decrease the overall surface tension and alter the distribution of polar and dispersive components describing the interactions. Fluoride containing salts showed opposite behavior in water and NMP which may be attributed to differences in solvation and hydrolysis of the salt. The nature of the anion had a more significant effect on residue removal than did the nature/size of cations. However, for the solvents, salts, and surfaces studied, the Hofmeister series did not allow accurate correlations with cleaning results. Estimations of the change in separation energy between the residue and the substrate as a function of specific cleaning solution correlates well with observed residue removal results.

While various solvatochromic characterization schemes exist, Owens-Wendt analysis appears to be useful in evaluation of the interactions between fluorocarbon based residues, substrates and solvent properties. The advantage of the Owens-Wendt method is that both solvents and surfaces can be characterized using a comparable scale. In addition, relatively few measurements are required to characterize the two interfaces of interest: solution/residue and residue/substrate. This analysis enables quantitative evaluation of the surface energy and the interfacial surface tension on surface (residue)-liquid, surface (residue)-surface (substrate) interfaces. This method also allows an estimation of the dispersive and polar character of the solutions and surfaces; optimization of these interactions can assist in the selection of appropriate cleaning solutions.

The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A removal solution for removing a residue from a substrate, a first interfacial tension existing between the residue and the substrate, comprising:
a. a polar solvent; and
b. an ionic salt dissolved into the polar solvent, thereby forming the removal solution, the ionic salt including at least one ion that, upon dissolution in the solvent, causes the removal solution to have a lower interfacial tension with the residue than the first interfacial tension.

2. The removal solution of claim 1, wherein the polar solvent comprises NMP.

3. The removal solution of claim 2, wherein the ionic salt includes a fluoride salt.

4. The removal solution of claim 3, wherein the fluoride salt is chosen from a group consisting of: TBAF, NH₄F, and combinations thereof.

5. The removal solution of claim 2, wherein the ionic salt includes an acetate.

6. The removal solution of claim 5, wherein the acetate comprises TMAAC.

7. The removal solution of claim 1, wherein the polar solvent comprises de-ionized water.

8. The removal solution of claim 7, wherein the ionic salt includes a fluoride salt.

9. The removal solution of claim 8, wherein the fluoride salt is chosen from a group consisting of: TBABF₄, NH₄F and combinations thereof.

10. The removal solution of claim 1, wherein the ionic salt has a concentration of 0.1 M.

11. The removal solution of claim 1, heated to a temperature of 70° C.

12. A method of cleaning a residue from a substrate, a first interfacial tension existing between the residue and the substrate, comprising the actions of:
a. selecting a polar solvent and an ionic salt so that a solution of the polar solvent and the ionic salt has an interfacial tension with the residue that is lower than the first interfacial tension;
b. dissolving the ionic salt, in a predetermined concentration, with the polar solvent to form a removal solution;
c. heating the removal solution to a predetermined temperature; and
d. placing the substrate and the residue into the removal solution while maintaining the removal solution at the predetermined temperature.

13. The method of claim 12, wherein the residue comprises a photoresist.

14. The method of claim 13, wherein the photoresist comprises a plasma etch photoresist.

15. The method of claim 12, wherein the selecting action comprises selecting NMP as the polar solvent.

16. The method of claim 12, wherein the ionic salt includes a fluoride salt and wherein the selecting action comprises the action of selecting a fluoride salt from a group consisting of: TBAF, NH4F, and combinations thereof.

17. The method of claim 12, wherein the ionic salt includes TMAAC.

18. The method of claim 12, wherein the selecting action comprises selecting de-ionized water as the polar solvent.

19. The method of claim 18, wherein the ionic salt includes a fluoride salt that is chosen from a group consisting of: TBABF4, NH4F and combinations thereof.

20. The method of claim 12, wherein the predetermined concentration comprises 0.1 M of the ionic salt.

21. The method of claim 12, wherein the predetermined temperature comprises 70° C.
